(19) United States
(12) Patent Application Publication
(10) Pub. No.: US 2022/0386089 A1
(43) Pub. Date: Dec. 1, 2022

(54) PORTABLE NETWORK-CONNECTED SIGNALING AND REPORTING DEVICE

(71) Applicant: Mark Rizk, Markham (CA)

(72) Inventor: Mark Rizk, Markham (CA)

(21) Appl. No.: 17/827,694

(22) Filed: May 28, 2022

Related U.S. Application Data
(60) Provisional application No. 63/194,914, filed on May 28, 2021.

(51) Int. Cl. H04W 4/38; G16Y 20/10; G16Y 40/10; H04W 8/20

(52) U.S. Cl. CPC H04W 4/38; G16Y 20/10; G16Y 40/10; H04W 8/205; H05B 45/10

(57) ABSTRACT

A Portable Network-Connected Signaling and Reporting Device that attaches to a portable power source. includes a potentiometer that controls the pulse width modulation/strobing of the at least one LED. The device includes but not limited to aluminum and plastic housing with a substantially cylindrical exterior profile for attachment to a power source. At least one electrical connection from the circuit and the power source is embedded in the housing and exposed for connection to an external charging source. The Portable Network-Connected Signaling and Reporting Device permits at least 1 electrical slot for external sensors. The external sensors can be attached to the body of the Portable Network-Connected Signaling and Reporting Device.

### FIELD OF TECHNOLOGY

The present specification is directed to devices for signaling and illuminating a specific environment. In addition to the illumination of an environment, the present specification is also directed to devices that accumulate information about its environment using external sensors.

### BACKGROUND

A vast number of devices in the safety industry function as Portable Network-Connected Signaling and Reporting Device, such as electronic flares, incendiary flares, smoke signals, etc. One common application of these Portable Network-Connected Signaling and Reporting Devices are being deployed at the scene of traffic incidents such as but not limited to automotive collisions. However, once deployed, the only function of these Portable Network-Connected Signaling and Reporting Device s is to visually notify nearby motorists of the incident on the road and to proceed with caution.

In addition to the limited function, incendiary flares and/or smoke signals can be extinguished by running any kind of vehicle over the signaling source. Often, they cannot endure severe usage cases and offer low durability. As well, the amount of visible light emitted from the incendiary flares can be low compared to the amount of energy wasted on the extreme heat created. And, smoke signals and incendiary flares comprise harmful chemicals and fumes that when burned or ignited, creating carcinogens that can cause or contribute to health problems to the user or any bystanders, particularly after repeated exposure.

There are valuable and insightful data points and metrics that are available to be considered such as but not limited to the size of the collision, number of vehicles involved, what are the license plates of the vehicle involved, and so on. Since multiple Portable Network-Connected Signaling and Reporting Device s are deployed around these traffic incidents, they have 360° coverage of the incident, making Portable Network-Connected Signaling and Reporting Device's a valid conduit to collecting the data points and metrics of traffic incidents. With the use of externally attached environment sensing sensors such as but not limited to proximity sensors, camera sensors, RFID sensors, and so on.

The preceding examples of the related art and limitations related to it are intended to be illustrative and not exclusive. Other limitations of the related art will become apparent to those of skill in the art upon a reading of the specification and a review of the drawings.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings.

FIG. 1 is an isometric view of the LED bulb of the Portable Network-Connected Signaling and Reporting Device without any sensors/modules attached to the bulb in accordance with a first example;

FIG. 2 is an isometric view of the LED bulb of the Portable Network-Connected Signaling and Reporting Device with at least one camera and proximity sensors attached to the bulb of FIG. 1;

FIG. 3 is a bottom perspective view of the method the LED bulb can attach to the main body of the Portable Network-Connected Signaling and Reporting Device;

FIG. 4 is an isometric view of an assembled Portable Network-Connected Signaling and Reporting Device that includes the LED bulb of FIG. 1; and

FIG. 5 is a flowchart diagram that outlines the technical process after at least one Portable Network-Connected Signaling and Reporting Device is deployed near or around a hazardous environment in accordance with the fourth example.

FIG. 6 is a flowchart diagram that outlines the software protocols of at least one Portable Network-Connected Signaling and Reporting Device when deployed near or around a hazardous environment in accordance with the fourth example.

### DETAILED DESCRIPTION

Representative apparatuses according to the present application are described in this section. These examples are being provided solely to add context and aid in the understanding of the described embodiments. It will thus be apparent to one skilled in the art that the described embodiments may be practiced without some or all these specific details. In other instances, well-known features have not been described in detail to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the scope of the described embodiments.

The following describes an exemplary Portable Network-Connected Signaling and Reporting Device that is capable of IoT connectivity that enables at least one sensor and or module attached to the LED bulb of the device to collect and transmit information to a server. At least one sensor and or module that can be attached to the exterior of the LED bulb of the Portable Network-Connected Signaling and Reporting Device can but not limited to environmental sensing sensors such as camera sensors, proximity sensors, light sensors, and so on. Once the Portable Network-Connected Signaling and Reporting Device is deployed around and or near the hazardous area, the LED bulb of the Portable Network-Connected Signaling and Reporting Device will use the external sensors and or modules to scan the environment for key data points that indicates the nature of the hazard. The device includes but not limited to a polycarbonate housing with substantially baton-shaped exterior profile for attachment to the circuit and a power source embedded within the housing for powering LED bulb. At least one electrical connection from the circuit and the power source is embedded in the housing and exposed for connection to an external charging source.

The following further describes an exemplary Portable Network-Connected Signaling and Reporting Device including: a cylindrical shape with a plurality of surfaces, which can be situated upon numerous surfaces or attached on the top and bottom surfaces. At least one light emitting diode within the housing, where when situated on a surface at either the top or bottom side of the device, light from the at least one light emitting diode emits through the omnidirectional transparent bulb at the top of the device. The device can be readily deployed and function in many surfaces and/or environments. Rechargeable batteries allow multiple uses of the device. This device can also emit light for extensive durations of time and features improved durability. The reflective material surrounding different components of the device allows for more visibility and attention to the area or environment the device is placed in. This waterproof, rugged device is equipped with handling various scenarios, such as marine applications, construction sites, roadside assistance, and so on. In addition to the hardware and or physical functionalities, the Portable Network-Connected Signaling and Reporting Device is capable of implementing data collection functions utilizing external sensors and or modules that can be mounted on at least one of the surfaces of the device. The data collection utilizes internet connectivity networks to transmit the data to a server—Internet connectivity networks includes 3G, 4G, LTE, and or Wi-Fi. These sensors and or modules permits the device to analyze the environment it is deployed and transmit said data into a server database using but not limited to an Internet of Things (IoT) process called Edge Computing.

The reporting function of the Portable Network-Connected Signaling and Reporting Device comprises of a digital application that permits user and or users to view the situational data of the environment where the device was deployed for investigative purposes. The data collected by the devices is filtered and categorized into a database using standard protocols/processes. The data in the database can demonstrated on the application in, but not limited to a dashboard framework that organizes the data in dedicated sections, an excel spreadsheet, or an electronic report. The nature of the reporting function can be both live reporting during an ongoing hazard or situation, and time-stamped reporting of past hazards. The nature of the reported data is including, but not limited to, vehicle collision metrics, live tracking of personnel wearing RFID tags to communicate with the device, and or live surveillance of an environment or private area.

The signaling function of the Portable Network-Connected Signaling and Reporting Device comprises of a visual signal, network-based signal, and an audible/vibrational signal. The visual signal is achieved through the embedded LED module that is capable of various strobe flashing patterns such as the Morse code pattern for S.O.S and solid light mode. The network-based signal is achieved through the internet connectivity of the signaling device and is executed using either a direct addressing mode where the signaling device is capable of sending an alert signal to an individual autonomous vehicle, drone/aerial vehicle, mobile device, and or computer sharing the same network or indirect addressing mode where the signaling device is capable of sending an alert to all autonomous vehicles, drones/aerial vehicles, mobile devices, and computers on the same network. The alert signal can consist of, but not limited to the signaling device's location coordinates, the level of threat in the environment, and surface area occupied within the perimeter of the devices deployed around it. The audible/vibrational signal is achieved using an audio amplification device such as but not limited to piezo speaker, electronic siren, or high-frequency tweeter speaker.

The portable nature of the Portable Network-Connected Signaling and Reporting Device is demonstrated through the device's portable DC power source that permits the versatile deployment of the device. The Portable Network-Connected Signaling and Reporting Device can be temporarily embedded in a structure, fixture, or any other environment to perform its signal and or reporting function.

Once the Portable Network-Connected Signaling and Reporting Device has completed its function in that environment, it can be removed and stored in case.

The use of the word: environment extends to the surroundings or conditions in which the Portable Network-Connected Signaling and Reporting Device is positioned. However, this term can be used to refer to an area where the Portable Network-Connected Signaling and Reporting Device can be used such as critical traffic situations, building fires, industrial sites, construction sites, crime scenes, airport runways, open fields, warehouses, and indoor facilities.

Mobile Machines and vehicles can be but not limited to autonomous vehicles, utility vehicles, construction vehicles, gas-powered automobiles, electric automobiles, hybrid automobiles, motorcycles, and off-road vehicles. Mobile machines can also include aerial machines such as drones, small airplanes, and helicopters.

The positioning of the Portable Network-Connected Signaling and Reporting Device refers to the manner of deployment. When the device is positioned in its environment of application, it can be temporarily embedded in the environment using but not limited to ground stakes or flat bases.

The field in which the Portable Network-Connected Signaling and Reporting Device is deployed in refers to the environment that require visual, audible, and or network-based signaling. Such fields can be but not limited to indoor environments such as hazardous institutions, warehouses, or industrial buildings. Such fields can also be but not limited to outdoor environments such as roads, forests, or private properties.

A Hazard can be defined as a danger or risk to an individual or group of people. Such hazards can be but not limited to traffic incidents, fires, chemical leakages, or violent weather.

Multi-Sensory Signaling refers to one of the device's abilities to utilize more than one than one method to stimulate a human's senses. Multi-Sensory Signaling can include but not limited to the combination of visual and audible signals, audible and network-based signals, or visual and network-based signals.

Multi-Sensory Verification refers to the device's method of using more than one sensor to discern between indoor or outdoor deployment. For example, if the proximity sensor senses more than one surface, the GPS coordinates indicates the general coordinates of a building, and the camera sensor can recognize indoor settings then the device will verify it is indoors. If the device verifies that it is indoors after the sensor data indicates such, then the device will execute indoor-only applications such as crowd control/screening. If the device verifies that its outdoors, then the device will execute outdoor-only applications such as outdoor hazard scanning.

Environmental Data refers to the quantifying factors of an environments such as location coordinates, temperature, objects, humans, and other relevant data points that is required by the device to capture the status of an environment.

Outdoor Deployment Mode refers to the device's selection of outdoor-only applications once the Multi-Sensory Verification indicates the device is outdoor. The applications can be but not limited to accident screening and reporting, indicator beacons for mobile Machines and vehicles, or surveillance.

Indoor Deployment Mode refers to the device's selection of indoor-only applications once the Multi-Sensory Verification indicates the device is indoor. The applications can be but not limited to crowd management, coordinated evacuation, or securing an indoor hazardous environment such as power generation plants.

Error Handling refers to the device's method of checking if the collected environmental data has been successfully transmitted to the server. The method scans the path of transmission for potential errors such as poor network connection, internal software issues or potential human factors that can hinder the device from transmitting the data successfully. The device's software will indicate to the user said error and proceed to autonomously troubleshoot the error.

The MISC Section of the electronic form is an added component to the form if there are any uncategorized (or miscellaneous) data points found in the environment the device was deployed in.

The Portable Network-Connected Signaling and Reporting Device can but not be limited to being equipped with at least one camera and proximity sensor to take panoramic photos of the hazardous environment it is deployed in. The camera sensors are programmed to read license plates when deployed around a traffic accident involving vehicles. Once scanned, the encrypted information is then transferred to our server database where we will be able to cross reference the registration information of the license plates involved in the accident (name of driver, type of vehicle, duration of accident, location of accident, number of vehicles involved, etc.). This information is funneled into a standardized online form which is then shared with the main parties involved with the accident (vehicle owners, the reporting police officer, etc.).

The Portable Network-Connected Signaling and Reporting Device can but not be limited to being equipped with at least one temperature reading sensor and proximity sensor to detect the temperatures of those who enter confined spaces such as offices, elevators, etc. These readings are immediately transferred to our server network where we will be able to send ping notifications to interested parties such as building administrators to notify them of any significantly high temperature reading and the location where this reading was recorded in order for swift action to take place. This is valuable for times of a global pandemic where immediate detection and reporting will provide health officials with valuable insight on the spread of the virus and or pandemic.

The Portable Network-Connected Signaling and Reporting Device can but not be limited to being equipped with at least one camera sensor and RFID (Radio-frequency identification) sensor that is paired with a detectable RFID tag or card which is embedded on a worker's person to ensure that only authorized worksite members can operate within the perimeter of the Portable Network-Connected Signaling and Reporting Devices. This ensures that authorized workers are within their areas of assigned operations, as well as discerning who is not authorized to operate within said perimeter. In doing this, the managers/supervisors of said worksite mitigate any liabilities if an unauthorized person is injured within this monitored perimeter.

The Portable Network-Connected Signaling and Reporting Device can but not be limited to being equipped with at least one RFID (Radio-frequency identification) sensor that is paired with a detectable RFID tag or card which is embedded in the packaging that is being transported in any medium of transportation (i.e. truck, freight, boat, and or airplane). If the vehicle that is transporting the packaging that includes the embedded tag and or card is disabled or halted for any reason, the Portable Network-Connected Signaling and Reporting Device can be deployed around the disabled vehicle to create a virtual mesh barrier. The Portable Network-Connected Signaling and Reporting Devices deployed around the vehicle will indicate if the packages stay within the perimeter of the devices and indicate whether the packages are taken out of said perimeter, where a ping notification will be sent to the invested parties involved with the shipment using our server database.

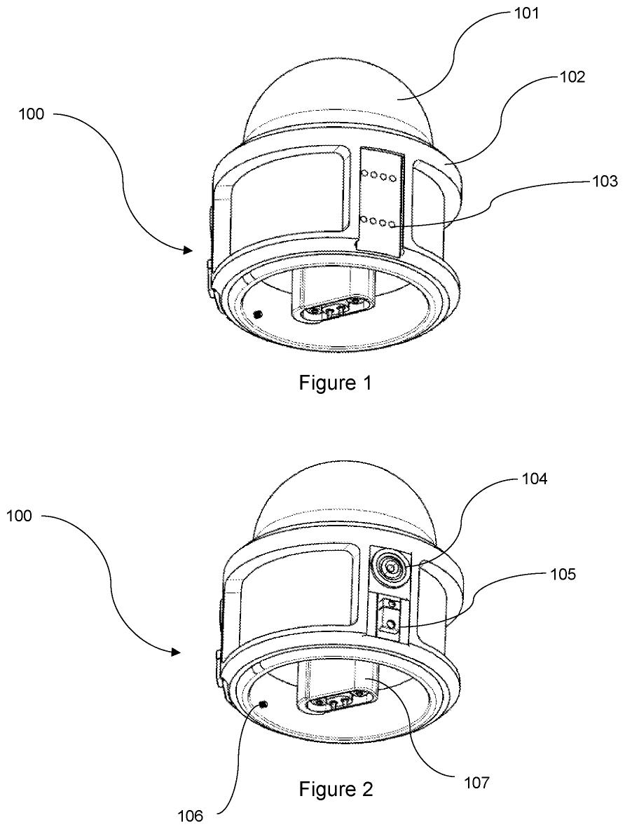

FIG. 1. illustrates an isometric view of the LED bulb of the Portable Network-Connected Signaling and Reporting Device without any sensors/modules attached to the bulb in accordance with a first example. The device 100 includes a transparent plastic cover that contains but not limited to a double concave lens that distributes the light of the Chip on Board LEDs. The outer housing 102 includes but not limited to an ABS plastic housing that contains at least one slot for sensors and or modules to be attached. The exposed electrical connections 103 are the connections that leads to the motherboard pins associated with each slot on the outer housing 102. The exposed electrical connections 103 permits at least one sensor or module to record data onto the temporary storage space on the device 100.

FIG. 2. illustrates an isometric view of the LED bulb of the Portable Network-Connected Signaling and Reporting Device with at least one camera 104 and proximity sensors 105 attached to the bulb of FIG. 1. The device 100 can allow at least one sensor and or module to be attached to at least one of surfaces of the device. The camera sensor 104 and proximity sensor 105 are examples of sensors and or modules that can externally attached to the device 100. The camera sensor 104 is capable of collecting visual data in the format of static pictures or videos. The proximity sensor can be but not limited to be programmed to detect nearby objects and observe the displacement of nearby objects. The locking pin 106 located on at least one surface of the device 100 permits the device to be secured to the body/handle of the portable device. The locking pin 106 ensures that the header pins for found on the port 107 is maintaining a consistent electrical connection with the power source located inside the body/handle of the device. The port 107 comprises of at least 2 header pins that are the positive and negative terminals that connect to the power source embedded inside the body/handle of the device.

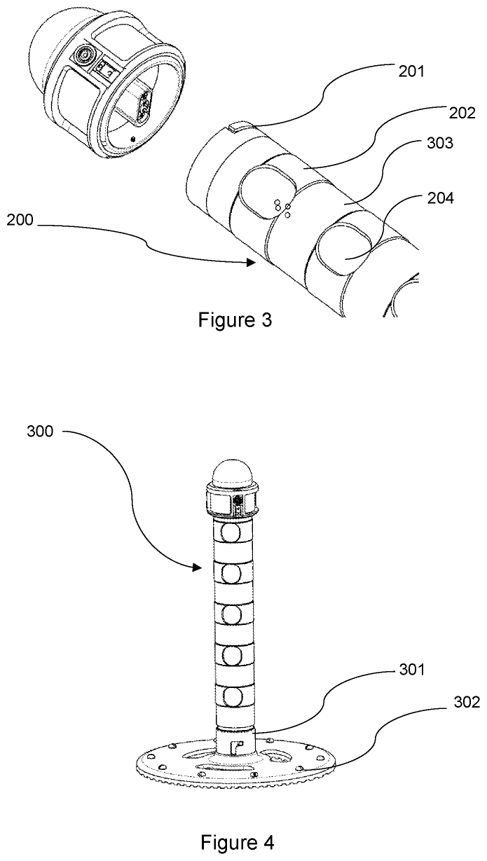

FIG. 3. illustrates a bottom perspective view of the method the LED bulb can attach to the main body of the Portable Network-Connected Signaling and Reporting Device. The device 200 is the main body and or handle of the signaling. The bayonet/locking track 201 of the device 200 engages at least one locking pin 106 found on the device 100 in the previous figure to secure device 100 (LED Bulb) to device 200 (main body of the Portable Network-Connected Signaling and Reporting Device). The rubber sleeve and or coating 202 comprises of but not limited to a silicone-based polymer that acts as a shock absorbent layer of protection for the device 200. In addition to the protective function of the rubber sleeve and or coating 202, it also contains a retro-reflective material 203 to provide the user with increased visibility of the device 100 without the excessive use of the power source of the device 200; allowing the more efficient use of the electrical energy of the device 100 along with a more cost-effective design. The core housing 204 of the device 200 is but not limited to a durable plastic housing such as polycarbonate to hold the power source for the device 100. The core housing 204 is designed to endure a wide range of environmental stresses while maintain the power delivered to the device 100.

FIG. 4. illustrates an isometric view of an assembled Portable Network-Connected Signaling and Reporting Device 300 comprising of devices 100 and 200 in the previous figures. The attachment adapter 301 comprises of at least one bayonet track to engage the locking pins of additional attachments that permits the device 300 to be deployed in a wider range of environments. The weighted base 302 is an example of the type of environment-tailored attachments the device 300 can utilize. The weighted base 302 is comprised of but not limited to a durable plastic material such as polycarbonate to endure roadside deployment on pavement/concrete. The weighed base 302 also comprises of but not limited to a ribbed rubber panel on the bottom surface of the attachment to promote higher frictional resistance between the surface it is deployed on and the device 300.

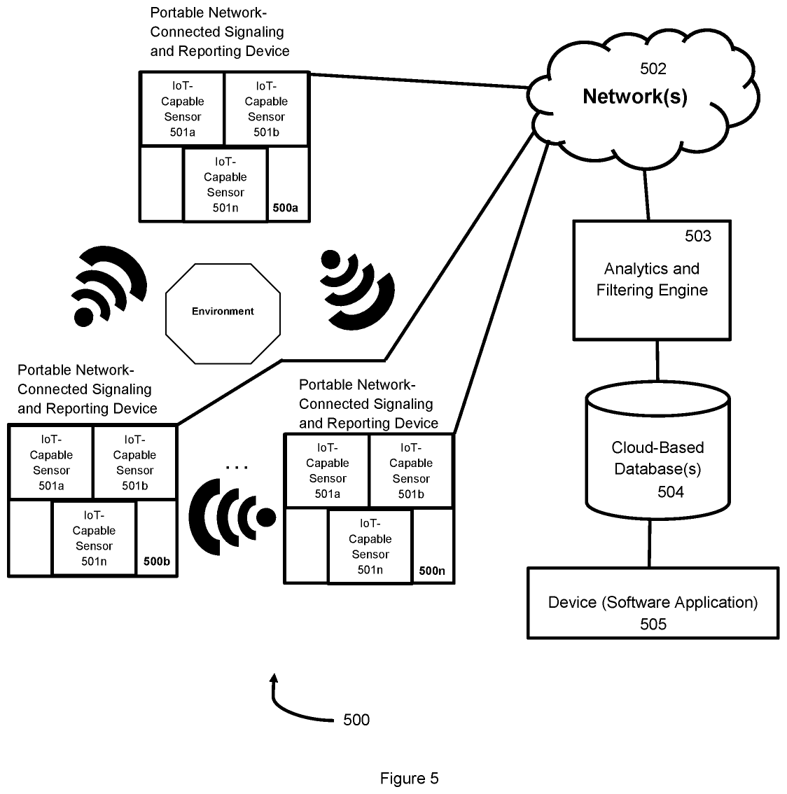

FIG. 5. illustrates a flowchart diagram that outlines the edge computing process of communication. Starting with the Portable Network-Connected Signaling and Reporting Devices (the edge devices) scanning and collecting the data points of the environment it is deployed in. The next phase is the data being transmitted using but not limited to a Wi-Fi or cellular signal to the server database where a data funnel algorithm organizes and categorizes information collected from the sensors on the LED bulb on the Portable Network-Connected Signaling and Reporting Device. The next phase involves categorizing the collected information into a standardized electronic form (i.e. duration of deployment, location coordinates, license plates involved in incident, etc.). The last phase of this process is the allowance of relevant third-party users to (i.e. police officers) access the standardized electronic forms associated to them in some degree through logging into server database for investigative purposes.

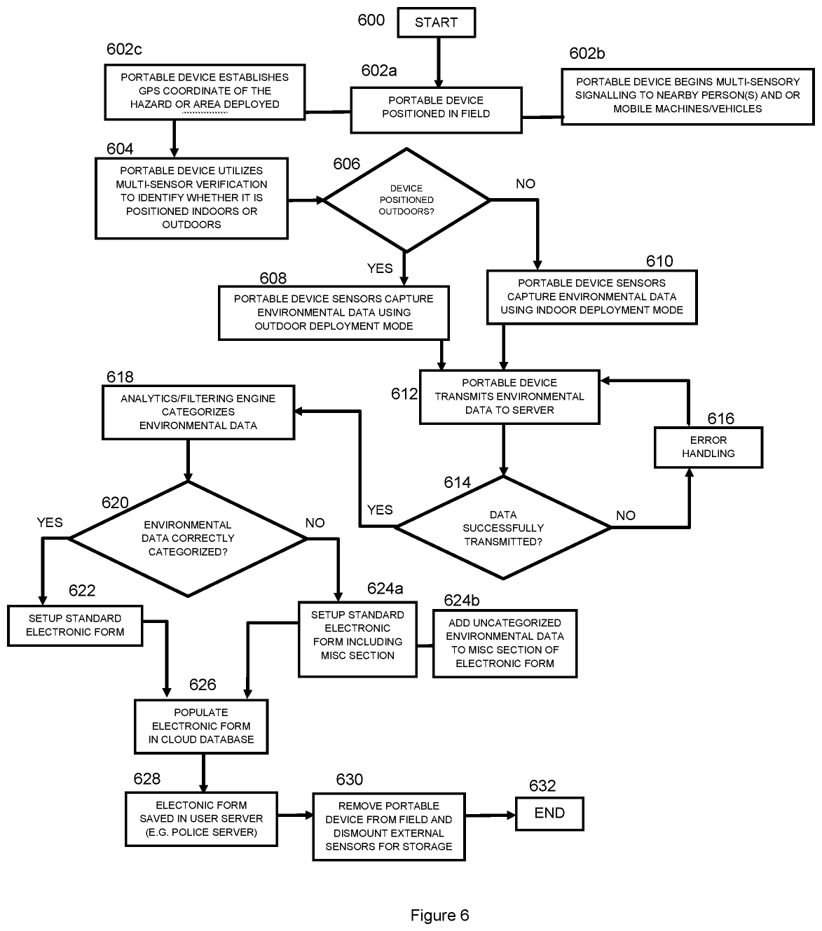

FIG. 6. Illustrates a flowchart diagram that outlines the software protocol the Portable Network-Connected Signaling and Reporting Devices automatically go through when deployed in a hazardous environment. The first phase of this protocol requires the device to start multi-sensory signaling (i.e. signal light starts strobe flashing, internal siren starts ringing, and a warning message is pinged to nearby devices) to caution nearby motorists and signaling. The next phase establishes GPS coordinate of the hazard or area deployed. The next phase utilizes multi-sensor verification sub-protocol (i.e. uses the camera, GPS, and ultrasonic sensor to detect indoor or outdoor landmarks)—this sub-protocol confirms whether the device is deployed indoor or outdoor which will influence the next phase. The next phase can either capture environmental data using outdoor deployment mode if device is outdoor or using indoor deployment mode if device is indoor. The next phase permits the device to transmit the environmental data to a server. The next phase processes the environmental in an analytics/filtering engine which then categorizes the environmental data (e.g. image of the accident, time stamps, GPS coordinates, etc.). The next phase is the setup of an electronic or digital form that will be used to organize the environmental data. The next phase is the population of the electronic form. The next phase saves the electronic form in the user's server. The final phase is the removal of the device from the environment and dismounting the external sensors for storage.

The invention claimed is:

1. Portable Network-Connected Signaling and Reporting Device that comprises of a modular and detachable LED bulb that is connected to but not limited to a portable power source; The Portable Network-Connected Signaling and Reporting Device comprises of sensors and modules that are connected via but not limited to external ports; The Portable Network-Connected Signaling and Reporting Device is capable of Internet of Things (IoT) functionality; IoT functionality refers to the communication between a node or device and a server utilizing internet connectivity networks; within the scope of this patent, the Portable Network-Connected Signaling and Reporting Device is identified as the node or device that collects raw data from an environment via it's sensors and modules; once the data is processed by the Portable Network-Connected Signaling and Reporting Device, the Portable Network-Connected Signaling and Reporting Device utilizes a SIM card to locate an internet connection to send the data to a server for the collection and storage of environmental or situational data around hazardous environments and environments that require caution for investigative purposes after the hazard is neutralized.

2. The Portable Network-Connected Signaling and Reporting Device of claim 1 further comprises but not limited to edge computing architecture into its electronic circuits.

3. The Portable Network-Connected Signaling and Reporting Device of claim 1 further comprises but not limited to slots that permit sensors and modules to be connected to its electronic circuits.

4. The Portable Network-Connected Signaling and Reporting Device of claim 1 further comprises the capability to communicate with identical Portable Network-Connected Signaling and Reporting Devices in a mesh configuration once deployed around but not limited to a hazardous environment and or area.

5. The Portable Network-Connected Signaling and Reporting Device of claim 1 further comprises the capability of communicating and or interacting with third-party devices that are also connected to but not limited to an internet connection.

6. A Portable Network-Connected Signaling and Reporting Device permits the connection of external sensors and or modules in order to assess an environment for key data points that represents the type of the environment and objects within said environment; Each sensor and or module attached to the Portable Network-Connected Signaling and Reporting Device collects situational data from a hazardous environment; situational data comprises of but not limited to time stamping, geographical coordinates, images of the hazard, and radial distance of hazard.

7. The Portable Network-Connected Signaling and Reporting Device of claim 6 further comprises the connection for a camera sensor that comprises but not limited to recognizing key data points of a hazardous environment utilizing image-recognition algorithms wherein such data points comprise but not limited to license plate recognition, human recognition, GPS coordinates, temperature, and weather.

8. The Portable Network-Connected Signaling and Reporting Device of claim 6 further comprises the connection for an ultrasonic sensor that comprises but not limited to detecting the distance of static and or dynamic objects relative to the device.

9. The Portable Network-Connected Signaling and Reporting Device of claim 6 further comprises the connection for a RFID sensor that comprises but not limited to detecting RFID transmitters such as but not limited to RFID tags.

10. The Portable Network-Connected Signaling and Reporting Device of claim 6 further comprises the connection for a temperature sensor that comprises but not limited to detecting the ambient temperature of the environment the device is deployed in.

11. The Portable Network-Connected Signaling and Reporting Device of claim 6 further comprises the connection for a pressure sensor that comprises of but not limited to measuring the pressure level of the environment the device is deployed in.

12. The Portable Network-Connected Signaling and Reporting Device of claim 6 further comprises the connection for an infrared sensor that comprises of but not limited to surveillance applications.

13. The Portable Network-Connected Signaling and Reporting Device of claim 6 further comprises the connection for a smoke, gas and alcohol Sensor that comprises of but not limited to detecting gases, smoke and or alcohol vapor in the environment it is deployed in.

14. A method for preparing an electronic and or digital form of the collected data of a Portable Network-Connected Signaling and Reporting Device: positioning the portable device in the field; portable device executing its multi-sensory signaling protocols to nearby person(s) and or mobile machines/vehicles; portable device establishing GPS coordinate of the hazard or area deployed; portable device utilizing multi-sensor verification protocols to identify whether it is positioned indoors or outdoors; portable device sensors capturing environmental data using outdoor deployment mode if positioning device outdoor; portable device sensors capturing environmental data using indoor deployment mode if positioning device indoor; portable device transmitting environmental data to a server; analytics/filtering engine categorizing environmental data; setting up electronic form according to environmental data; populating the electronic form in a cloud database; saving electronic form in user server; removing portable device from field and dismounting external sensors for storage.
